(19) United States
(12) Patent Application Publication
(10) Pub. No.: US 2025/0087901 A1
(43) Pub. Date: Mar. 13, 2025

(54) PLANAR ANTENNA AND ANTENNA DEVICE

(71) Applicant: NEC Corporation, Tokyo (JP)

(72) Inventors: Kohei YOSHIDA, Tokyo (JP); Fujio Okumura, Kanagawa (JP)

(73) Assignee: NEC Corporation, Tokyo (JP)

(21) Appl. No.: 18/809,799

(22) Filed: Aug. 20, 2024

(30) Foreign Application Priority Data
Sep. 9, 2023 (JP) 2023-150692

(51) Int. Cl. H01Q 21/06; H01Q 9/04

(52) U.S. Cl. CPC H01Q 21/065; H01Q 9/0407

(57) ABSTRACT

Provided is a planar antenna including an antenna array in which a plurality of patch antennas are disposed in a two-dimensional array; a substrate on which a phase shifter layer including a phase shifter associated with each of the plurality of patch antennas and wiring used for controlling the phase shifter is formed; a signal line that is formed on the same face as the antenna array and through which a communication signal propagates; and a ground layer disposed between the phase shifter layer and the signal line, and having a slot formed at least between the signal line and the phase shifter.

This application is based upon and claims the benefit of priority from Japanese Patent Application No. 2023-150692, filed on Sep. 19, 2023, the disclosure of which is incorporated herein in its entirety by reference.

### TECHNICAL FIELD

The present disclosure relates to a planar antenna and an antenna device.

### BACKGROUND ART

PTL 1 (JP 11-074717 A) discloses a phased array antenna device having a plurality of radiating elements. The device of PTL 1 has a multilayer structure including a plurality of radiating elements, a plurality of phase shifters, a phase shift control circuit, and a power supply unit. The phase shifter is coupled to any of the radiating elements and shifts the phase of the power supply signal supplied to the radiating element bit by bit. The phase shift control circuit controls phase shifts of the plurality of phase shifters. The power supply unit is coupled with the radiating element.

According to the configuration of PTL 1, the antenna gain can be improved by increasing the number of elements. However, when the number of elements is increased to a scale of 10,000, there is a possibility that a wiring line used for selecting a phase shifter or writing data and a signal line intersect with each other and interfere with each other. When a wiring line used for selecting a phase shifter or writing data and a signal line interfere with each other, the characteristic impedance of the signal line may fluctuate.

An object of the present disclosure is to provide a planar antenna and an antenna device in which fluctuations in characteristic impedance in a signal line is suppressed.

### SUMMARY

A planar antenna according to an aspect of the present disclosure includes an antenna array in which a plurality of patch antennas are disposed in a two-dimensional array; a substrate on which a phase shifter layer including a phase shifter associated with each of the plurality of patch antennas and wiring used for controlling the phase shifter is formed; a signal line that is formed on the same face as the antenna array and through which a communication signal propagates; and a ground layer disposed between the phase shifter layer and the signal line, and having a slot formed at least between the signal line and the phase shifter.

### BRIEF DESCRIPTION OF THE DRAWINGS

Exemplary features and advantages of the present disclosure will become apparent from the following detailed description when taken with the accompanying drawings in which:

FIG. 1 is a conceptual diagram illustrating an example of a configuration of a planar antenna according to the present disclosure;

FIG. 2 is a conceptual diagram illustrating an example of a configuration of a planar antenna according to the present disclosure;

FIG. 3 is a conceptual diagram for describing an example of a phase shifter memory included in a planar antenna in the present disclosure;

FIG. 4 is a conceptual diagram for describing an example of a switch included in a planar antenna in the present disclosure;

FIG. 5 is a conceptual diagram illustrating an example of a configuration of a planar antenna in the present disclosure;

FIG. 6 is a conceptual diagram illustrating an example of a configuration of a planar antenna according to the present disclosure;

FIG. 7 is a conceptual diagram illustrating an example of a configuration of a planar antenna according to the present disclosure;

FIG. 8 is a conceptual diagram for describing an example of a planar antenna in the comparative example;

FIG. 9 is a conceptual diagram for describing an example of a planar antenna in the comparative example;

FIG. 10 is a conceptual diagram illustrating an example of a configuration of a planar antenna in the comparative example;

FIG. 11 is a conceptual diagram illustrating an example of a configuration of an antenna device according to the present disclosure;

FIG. 12 is a block diagram illustrating an example of a configuration of an antenna device according to the present disclosure;

FIG. 13 is a conceptual diagram illustrating an example of a configuration of a planar antenna according to the present disclosure; and

FIG. 14 is a block diagram illustrating an example of a hardware configuration that executes control and processing according to each example embodiment.

### EXAMPLE EMBODIMENT

Example embodiments of the present disclosure will be described below with reference to the drawings. In the following example embodiments, technically preferable limitations are imposed to carry out the present disclosure, but the scope of this disclosure is not limited to the following description. In all drawings used to describe the following example embodiments, the same reference numerals denote similar parts unless otherwise specified. In addition, in the following example embodiments, a repetitive description of similar configurations or arrangements and operations may be omitted.

### (First Example Embodiment)

First, a planar antenna according to a first example embodiment will be described with reference to the drawings. The planar antenna of the present example embodiment includes a patch antenna that is a type of planar antenna. Hereinafter, description of a transmission device that transmits a radio wave from the planar antenna and a reception device that receives a radio wave received by the planar antenna will be omitted. For example, the planar antenna of the present example embodiment is used for transmission and reception of electromagnetic waves in a high frequency band expected to be applied to mobile communication of a Beyond 5 Generation (B5G) subsequent to a 5 Generation (5G). For example, the planar antenna of the present example embodiment is used for transmission and reception of signals of millimeter waves or terahertz waves. The planar antenna of the present example embodiment may be used for transmission and reception of signals other than millimeter waves and terahertz waves.

For example, the planar antenna of the present example embodiment includes a phase shift element formed using a micro light-emitting diode (LED) display manufacturing processing technology. The planar antenna of the present example embodiment includes a switching element formed using a thin film transistor (TFT) manufacturing processing technology. In the production of the planar antenna of the present example embodiment, a micro LED display manufacturing processing technology (micro LED processing technology) and a thin film transistor manufacturing processing technology (TFT processing technology) are combined. The planar antenna of the present example embodiment may be manufactured using a technology other than the micro LED processing technology and the TFT processing technology.

### (Configuration)

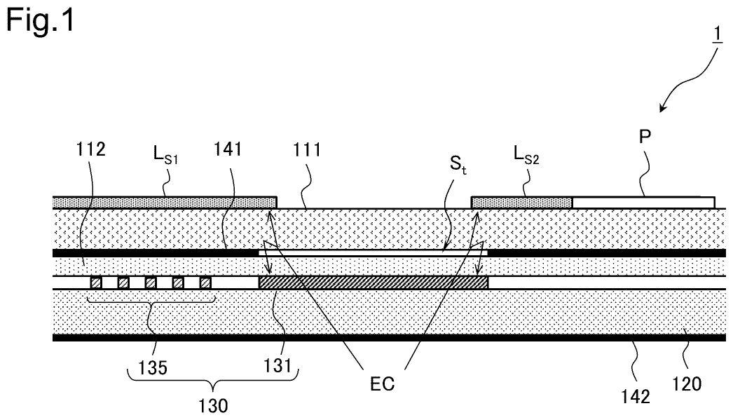

FIG. 1 is a cross-sectional view illustrating a cross section of part of a planar antenna in the present disclosure. The planar antenna 1 of the present example embodiment includes a patch antenna P, a first insulating layer 111, a second insulating layer 112, a TFT substrate 120, a phase shifter layer 130, a ground layer 141, and a ground layer 142. A phase shifter 131 and a TFT wiring 135 are formed in the phase shifter layer 130. The TFT wiring 135 includes wiring such as selection lines and data lines used for controlling the phase shifter. The planar antenna 1 includes signal lines (signal line L_{S1}, signal line L_{S2}) connected to a signal source (not illustrated). The signal line L_{S1} and the signal line L_{S1} are formed in the same layer as the patch antenna P. That is, the planar antenna 1 is a coplanar type planar antenna in which the patch antenna P and the signal line are formed on the same plane.

The first insulating layer 111 is formed on the surface of the planar antenna 1. A patch antenna array is disposed on the upper face of the first insulating layer 111. The patch antenna array includes a plurality of patch antennas P. Although a single patch antenna P is illustrated in FIG. 1, the planar antenna 1 includes a plurality of patch antennas P. The plurality of patch antennas P are disposed in a lattice shape along two directions orthogonal to each other. The plurality of patch antennas P is phased arrayed. The patch antenna P is a plate-shaped radiating element. For example, the patch antenna P has a square shape. The shape of the patch antenna P is not limited to a square shape, and may be a circular shape or other shapes.

The signal line L_{S1} and the signal line L_{S1} are disposed on the upper face of the first insulating layer 111. The signal line L_{S1} (first signal line) is a signal line through which a signal before phase shift supplied from a signal source is propagated. A first end of the signal line L_{S1} is connected to a signal source. The second end of the signal line L_{S1} is disposed above the first end of the phase shifter 131. The second end of the signal line L_{S1} functions as an open end of the microstrip line. The second end of the signal line L_{S1} is connected to the first end of the phase shifter 131 by electromagnetic coupling electromagnetic coupling (EC) via the phase shifter slot Sₜ. The capacitance related to the dielectric constant of the first insulating layer 111, the air layer in the portion of the phase shifter slot Sₜ, and the second insulating layer 112 is formed between the signal line L_{S1} and the phase shifter 131.

A signal line L_{S2} (second signal line) is a signal line through which the phase-shifted signal phase-shifted by the phase shifter 131 is propagated to the patch antenna P. The signal line L_{S2} may be formed integrally with the patch antenna P. The first end of the signal line L_{S2} is disposed above the second end of the phase shifter 131. The first end of the signal line L_{S2} functions as an open end of the microstrip line. The first end of the signal line L_{S2} is connected to the second end of the phase shifter 131 by the electromagnetic coupling EC via the phase shifter slot Sₜ. The capacitance related to the dielectric constant of the first insulating layer 111, the air layer in the portion of the phase shifter slot St, and the second insulating layer 112 is formed between the signal line L_{S2} and the phase shifter 131. The second end of the signal line L_{S2} is connected to the patch antenna P.

The signal supplied from the signal source is propagated from the signal line L_{S1} to the phase shifter 131 by the electromagnetic coupling EC via the phase shifter slot Sₜ.

The phase of the signal propagated to the phase shifter 131 is shifted. The signal whose phase is shifted by the phase shifter 131 is propagated from the phase shifter 131 to the signal line L_{S2} by the electromagnetic coupling EC via the phase shifter slot Sₜ. The signal whose phase is shifted by the phase shifter propagates through the signal line L_{S2} and is transmitted to the patch antenna P. The signal propagated to the patch antenna P is transmitted as a radio signal from the phased array antenna configured by the plurality of patch antennas P.

The first insulating layer 111 is stacked on the upper face of the ground layer 141. For example, the material of the first insulating layer 111 is glass, or resin such as glass epoxy, tetrafluoroethylene or epoxy. The first insulating layer 111 may be made of a material other than glass, or resin such as glass epoxy, tetrafluoroethylene or epoxy, as long as it can transmit and receive communication radio waves. The ground layer 141 is disposed on the lower face of the first insulating layer 111. The ground layer 141 blocks electromagnetic coupling between the upper and lower sides of the ground layer 141. The ground layer 141 is made of an electric conductor. For example, a material of the ground layer 141 is metal (including alloy) such as copper, aluminum, and chromium. The potential of the ground layer 141 is a ground potential. The lower face of the ground layer 141 is in contact with the upper face of the ground layer 141.

The ground layer 141 has a plurality of openings. The opening formed in the ground layer 141 is referred to as a slot. The slot includes the phase shifter slot Sₜ. The phase shifter slot Sₜ is formed between the phase shifter layer 130 and the signal line. In the example of FIG. 1, the ground layer 141 has one type of phase shifter slot Sₜ. The phase shifter slot Sₜ is formed above the phase shifter 131 formed in the phase shifter layer 130.

The second insulating layer 112 is formed under the ground layer 141. TFT substrate 120 is disposed below the second insulating layer 112. The upper face of the second insulating layer 112 is in contact with the lower face of the ground layer 141. Part of the upper face of the second insulating layer 112 faces part of the lower face of the first insulating layer 111 via the phase shifter slot St formed in the ground layer 141. The lower face of second insulating layer 112 is in contact with the TFT wiring 135 formed on the upper face of the TFT substrate 120 and the phase shifter layer 130. For example, the material of the second insulating layer 112 is glass, glass epoxy, or resin such as tetrafluoroethylene or epoxy. The second insulating layer 112 may be made of a material other than glass, or resin such as glass epoxy, tetrafluoroethylene or epoxy, as long as it can transmit and receive communication radio waves.

TFT substrate 120 is disposed below the second insulating layer 112. For example, a material of the TFT substrate 120 is a dielectric such as glass. TFT wiring 135 and the phase shifter layer 130 are formed on an upper face of the TFT substrate 120.

The TFT wiring 135 includes a plurality of selection lines used to select a phase shifter and a plurality of data lines used to write phase shift data to the phase shifter. A matrix circuit is formed on the upper face of the TFT substrate 120. The matrix circuit has a structure in which a plurality of thin film transistors (TFT) is disposed in a two-dimensional array. For example, the TFT included in the matrix circuit is formed using a TFT processing technology. A signal layer is formed above the matrix circuit. In the signal layer, wiring constituting the phase shift element, a switch group including a plurality of switching elements, and wiring for connecting wiring constituting the phase shift element and the switch group are formed. For example, the switching elements are formed using the micro-LED processing technology. For example, a material of the TFT substrate 120 is glass, or resin such as glass epoxy, tetrafluoroethylene or epoxy. The TFT substrate 120 may be made of a material other than glass, or resin such as glass epoxy, tetrafluoroethylene or epoxy as long as it can transmit and receive communication radio waves.

The ground layer 142 (second ground layer) is disposed on the lower face of the TFT substrate 120. The ground layer 142 is also referred to as a ground plate. The ground layer 142 is made of an electric conductor. The characteristic impedance of the portion of the phase shifter 131 is ensured between the phase shifter 131 and the ground layer 141. For example, a material of the ground layer 142 is metal (including alloy) such as copper, aluminum, and chromium. The potential of the ground layer 142 is a ground potential.

The patch antenna P is fed through a signal line L_{S2} disposed on the same plane. The patch antenna P is excited by the power supply through the signal line L_{S2}. The resonance frequency of the patch antenna P is an integral multiple of ½ of a wavelength corresponding to the length of one side of the patch antenna P. The size of the patch antenna P is set according to the wavelength of the radio wave to be transmitted.

The patch antenna P is preferably configured in such a way that a signal (radio wave) is easily radiated into space. On the other hand, it is preferable that an internal wiring such as a signal line or a wiring is less likely to emit a signal. That is, the smaller the dielectric constant required around the patch antenna P, the better, and the larger the dielectric constant required around the internal wiring, the better. Therefore, it is preferable that different manufacturing processes are applied to the structure around the patch antenna P and the structure around the internal wiring. For example, by applying a method in which a structure around the patch antenna P is formed by a liquid crystal process and a structure around the internal wiring is formed by a thin film process, the structure of the planar antenna 1 of the present example embodiment can be achieved.

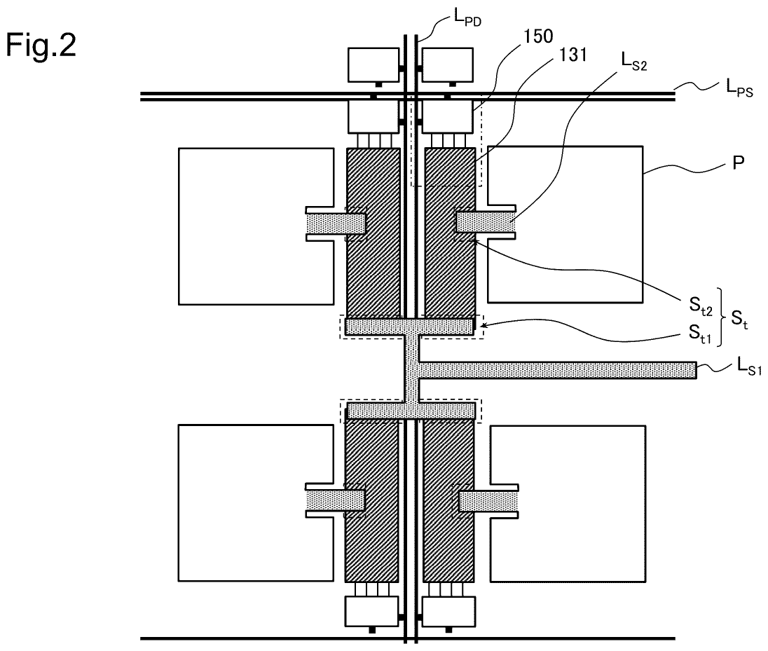

FIG. 2 is a plan view of part of the planar antenna in the present disclosure. In FIG. 2, the first insulating layer 111, the second insulating layer 112, the TFT substrate 120, the ground layer 141, and the ground layer 142 are omitted. FIG. 2 illustrates a positional relationship between the patch antenna P, the phase shifter 131 formed in the phase shifter layer 130, and the signal line L_{S}. FIG. 2 illustrates a selection line L_{PS}, a data line L_{PD}, and a phase shifter memory 150.

As illustrated in FIG. 2, the signal line L_{S1} and the signal line L_{S2} are disposed at positions avoiding below the selection line L_{PS} and the data line L_{PD}. In the example of FIG. 2, the signal line L_{S1} has a first end branched into four. The first end of the signal line L_{S1} passes beneath the phase shifter 131 via the phase shifter slot Sₜ. The signal line L_{S1} is electromagnetically coupled to the phase shifter 131 via the phase shifter slot Sₜ. The signal line L_{S2} is electrically connected to the patch antenna P.

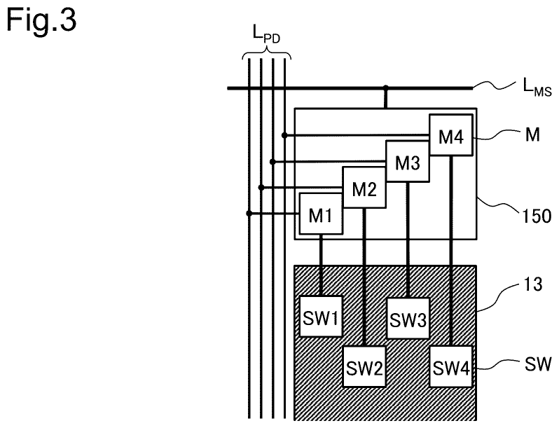

FIG. 3 is a conceptual diagram for describing the phase shifter memory 150. The phase shifter memory 150 includes a number of memories M related to the number of bits. In the example of FIG. 3, phase shifter memory 150 has 4 bits. The phase shifter memory 150 includes four memories M (M1, M2, M3, M4). FIG. 3 illustrates a memory selection line L_{MS} for making the memory M included in the phase shifter memory 150 writable. A data line L_{D} for writing data to the memory M is illustrated. In the example of FIG. 3, four data lines L_{D} disposed in association with the plurality of memories M is illustrated.

In the phase shifter 13, a plurality of switch groups SW (SW1, SW2, SW3, SW4) associated with the plurality of memories M is disposed. For example, in a case where the phase shifter 131 is a 4-bit line switching type, the switch group SW includes 4 switches (16 switches in total) per bit. The switch group SW1 is connected to the memory M1. The switch group SW2 is connected to the memory M2. The switch group SW3 is connected to the memory M3. The switch group SW4 is connected to the memory M4. For example, the switch group SW includes a switching element including a thin film of vanadium dioxide VO₂.

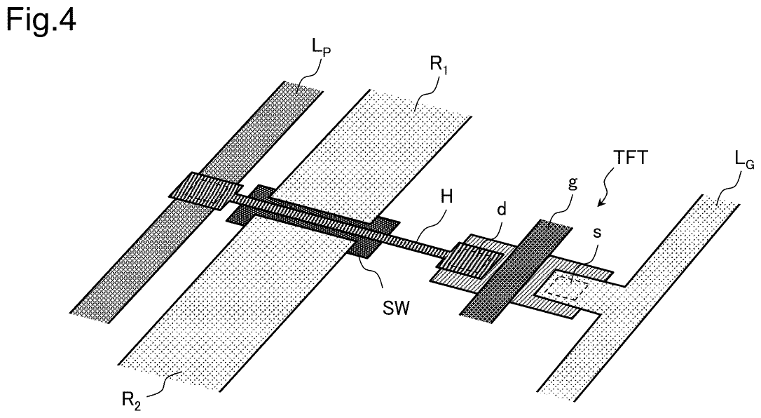

FIG. 4 is a conceptual diagram for describing a configuration of the switch group SW including a switching element including a thin film of vanadium dioxide VO₂. FIG. 4 illustrates an example in which a transmission line R₁ and a transmission line R₂ are electrically connected via the switch group SW. A heating line H is thermally connected to the switch group SW. The first end of heating line H is connected to a power supply line L_{P}. The second end of the power supply line L_{P} is connected to a drain d of the TFT. The source of the TFT is connected to a ground line L_{G}. When a gate voltage is applied to a gate g of the TFT, a current is supplied from the power supply line L_{P} between the drain d and a source s of the TFT. The current from the power supply line L_{P} is supplied to the TFT via the heating line H. When the current flows through the heating line H, the heating line H generates heat. When the temperature of the switch group SW in contact with the heating line H exceeds the phase transition temperature of the vanadium dioxide VO₂, the switch group SW transitions to the ON state. When the switch group SW transitions to the ON state, the transmission line R₁ and the transmission line R₂ are electrically connected. In the present example embodiment, the transmission line R₁ is connected to the memory M, and the transmission line R₂ is connected to the phase shifter 131.

The phase shifter 131 is formed by the TFT process. For example, as in the examples of FIGS. 3 to 4, the phase shifter 131 is provided with a switch group SW of the vanadium dioxide VO₂. For example, a signal line that gives a phase level to a plurality of phase shifters 131 disposed in a matrix and the memory M that stores data for each phase shifter 131 are formed as a TFT circuit. Therefore, in the planar antenna 1, internal wiring such as signal lines and selection lines are disposed in a matrix. Portions where these internal wiring intersect are separated with the ground layer 141 interposed between the separated portions. Therefore, in the planar antenna 1 of the present example embodiment, the dielectric constant around the patch antenna P and the dielectric constant around the internal wiring can be set to completely different values. That is, according to the present example embodiment, the dielectric constant around the patch antenna P and the dielectric constant around the internal wiring can be set to values according to respective requirements.

### (Modifications)

Next, the modifications of the planar antenna 1 of the present example embodiment will be described with reference to the drawings. In the following description, description of the matters described so far may be omitted. The following modification is an example, and does not limit the configuration of the planar antenna 1 of the present example embodiment.

### [First Modification]

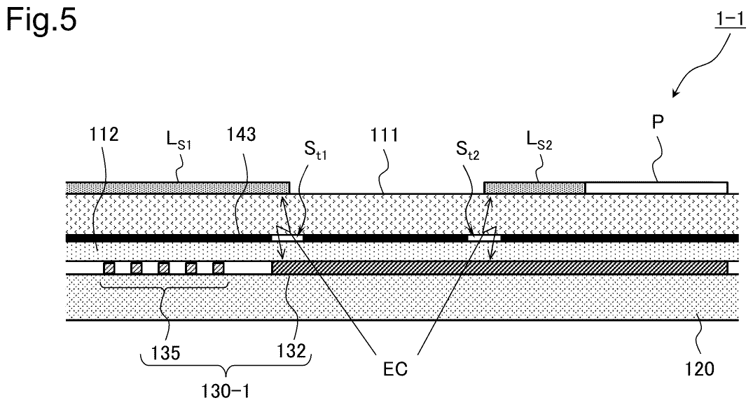

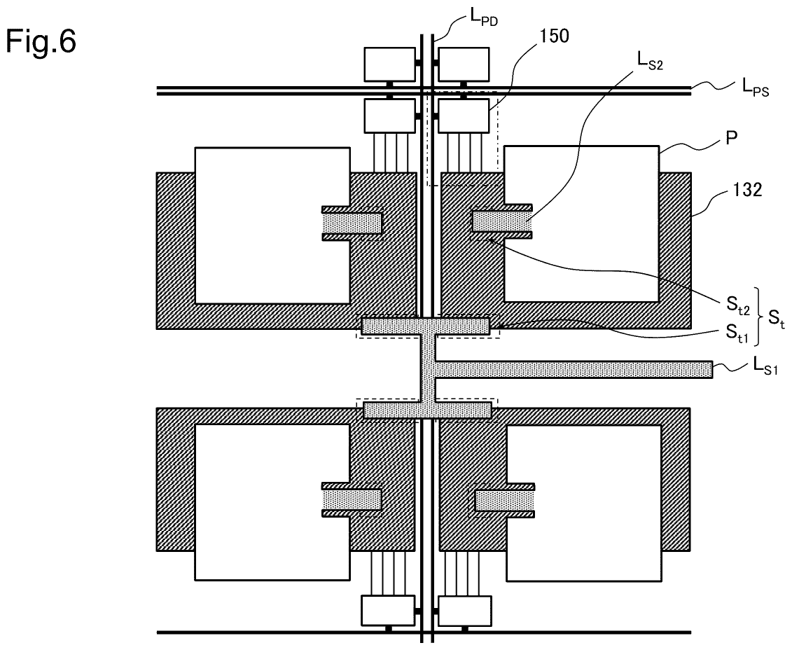

FIG. 5 is a cross-sectional view illustrating a cross section of part of a planar antenna in the present disclosure. FIG. 6 is a plan view illustrating an upper face of part of the planar antenna in the present disclosure. A planar antenna 1-1 of the first modification has a configuration in which the ground layer is single in the planar antenna 1 (FIG. 1).

A phase shifter 132 and the TFT wiring 135 are formed in a phase shifter layer 130-1. The phase shifter 132 extends to a lower region of the patch antenna P. The ground layer 141 has two types of phase shifter slots Sₜ (phase shifter slot Sₜ, phase shifter slot Sₜ₂). The phase shifter slot Sₜ₁ is formed between the first end of the phase shifter 132 and the second end of the signal line L_{S1}. The phase shifter slot Sₜ₂ is formed between part of the upper face of the phase shifter 132 and the first end of the signal line L_{S2}.

In the planar antenna 1-1, the signal line L_{S1} and the phase shifter 132 are connected by the electromagnetic coupling EC via the phase shifter slot Sₜ₁. In the planar antenna 1-1, the signal line L_{S2} and the phase shifter 132 are connected by the electromagnetic coupling EC via the phase shifter slot Sₜ₂. According to the present modification, since the phase shifter 132 can be extended below the patch antenna P, the degree of freedom of the shape and size of the phase shifter 132 is larger than that of the planar antenna 1 (FIG. 1). According to the configuration of the present modification, a phase shifter having a plurality of lines or a phase shifter having a long line length can be applied. According to the present modification, since the characteristic impedance can be secured between the phase shifter 132 and the ground layer 143, the ground layer 142 of the planar antenna 1 (FIG. 1) is unnecessary.

### [Second Modification]

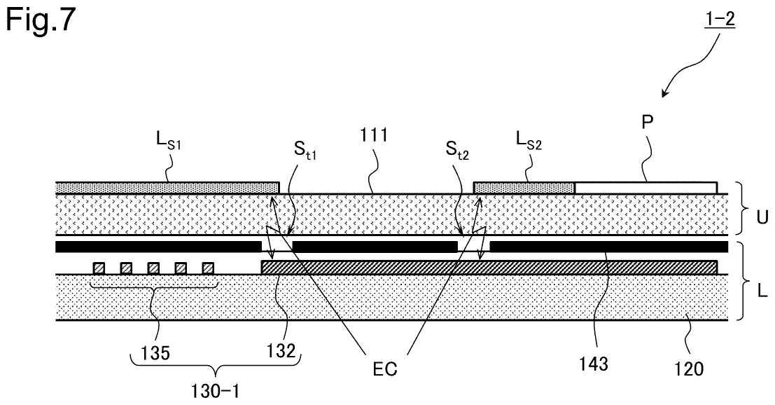

FIG. 7 is a cross-sectional view illustrating a cross section of part of a planar antenna in the present disclosure. The planar antenna 1-2 of the second modification is an example in which an upper layer structure U and a lower layer structure L are separately formed. The upper layer structure U includes the patch antenna P, the signal line L_{S2}, the signal line L_{S1}, and the first insulating layer 111. The lower layer structure L includes a ground layer 143 and the TFT substrate 120 on the upper face of which the phase shifter layer 130-1 is formed. A dielectric layer (not illustrated) is disposed between the upper layer structure U and the lower layer structure L.

A phase shifter 132 and the TFT wiring 135 are formed in a phase shifter layer 130-1. The phase shifter 132 extends to a lower region of the patch antenna P. The ground layer 141 has two types of phase shifter slots Sₜ (phase shifter slot Sₜ₁, phase shifter slot Sₜ₂). The phase shifter slot Sₜ₁ is formed between the first end of the phase shifter 132 and the second end of the signal line L_{S1}. The phase shifter slot Sₜ₂ is formed between part of the upper face of the phase shifter 132 and the first end of the signal line L_{S2}.

In the planar antenna 1-2, the signal line L_{S1} and the phase shifter 132 are connected by the electromagnetic coupling EC via the phase shifter slot Sₜ₁. In the planar antenna 1-1, the signal line L_{S2} and the phase shifter 132 are connected by the electromagnetic coupling EC via the phase shifter slot Sₜ₂. According to the present modification, the TFT substrate 120 and the ground layer 143 can be integrally formed by the TFT processing technology. According to the configuration of the present modification, the upper layer structure U and the lower layer structure L can be manufactured by different manufacturing methods. For example, the upper layer structure U can be manufactured by the micro LED processing technology, and the lower layer structure L can be manufactured by the TFT processing technology. Therefore, the present modification has a greater degree of freedom in manufacturing than the first modification.

### COMPARATIVE EXAMPLE

Next, comparative examples of the present example embodiment will be described with reference to the drawings. The following comparative example relates to a two-dimensional phased array antenna that drives a phase shifter with a TFT. In a case where the phase shifter is driven by the TFT, wiring used for selection of the phase shifter and writing of phase shift data is formed. In the following comparative example, a diagram in which a wiring portion is emphasized is used.

### First Comparative Example

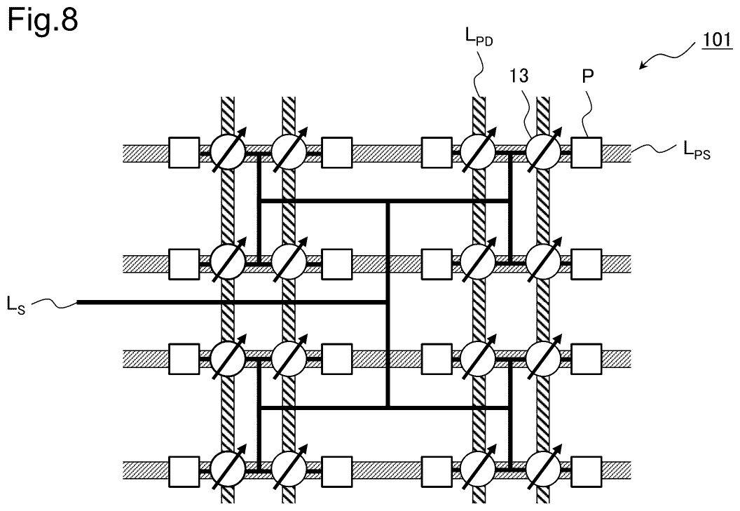

FIG. 8 is a plan view of a planar antenna according to the first comparative example. A planar antenna 101 of the present comparative example includes a plurality of patch antennas P and a plurality of phase shifters 13 disposed in a lattice pattern. The planar antenna 101 includes a plurality of selection lines L_{PS} and a plurality of data lines L_{PD}. Furthermore, the planar antenna 101 includes a signal line L_{S} for transmitting a signal (radio wave) emitted from the patch antenna P.

The plurality of selection lines L_{PS} is extended in the row direction. Each of the plurality of selection lines L_{PS} passes through the plurality of phase shifters 13 disposed in the row direction. Each of the plurality of selection lines L_{PS} passes beneath the plurality of patch antennas P disposed in the row direction. The selection line L_{PS} is used to select the phase shifter 13.

The plurality of data lines L_{PD} is extended in the column direction. Each of the plurality of data lines L_{PD} passes through the plurality of phase shifters 13 disposed in the column direction. The data line L_{PD} is used for writing phase shift data to the phase shifter 13.

In the layout of the present comparative example, the signal line L_{S} intersects the selection line L_{PS} and the data line L_{PD} at a plurality of locations. Interference may occur at a portion where the signal line L_{S} and the wiring intersect. In the layout of the present comparative example, there is also a portion where the selection line L_{PS} and the patch antenna P intersect.

### Second Comparative Example

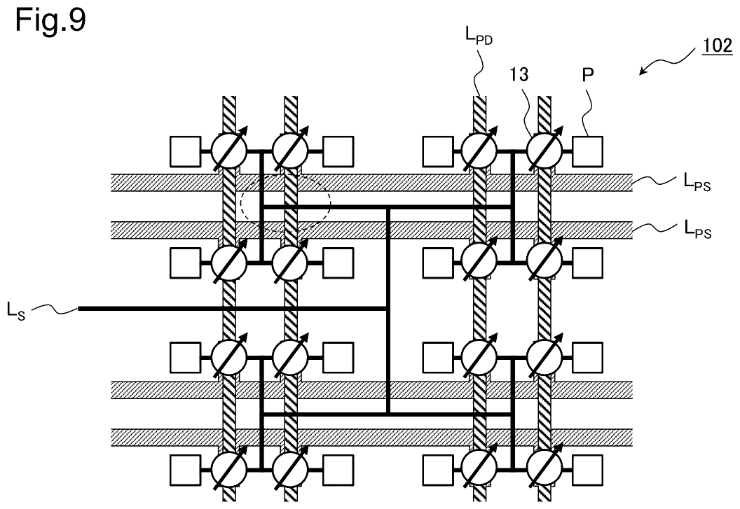

FIG. 9 is a plan view of a planar antenna according to the second comparative example. A planar antenna 102 of the present comparative example includes a plurality of patch antennas P and a plurality of phase shifters 13 disposed in a lattice pattern. The planar antenna 102 includes a plurality of selection lines L_{PS} and a plurality of data lines L_{PD}. Furthermore, the planar antenna 102 includes a signal line L_{S} for transmitting a signal (radio wave) emitted from the patch antenna P.

The plurality of selection lines L_{PS} is extended in the row direction. Each of the plurality of selection lines L_{PS} is disposed avoiding the plurality of phase shifters 13 disposed in the row direction. Each of the plurality of selection lines L_{PS} is disposed avoiding the plurality of patch antennas P disposed in the row direction. The selection line L_{PS} is used to select the phase shifter 13.

The plurality of data lines L_{PD} is extended in the column direction. Each of the plurality of data lines L_{PD} passes through the plurality of phase shifters 13 disposed in the column direction. The data line L_{PD} is used for writing phase shift data to the phase shifter 13.

In the layout of the present comparative example, there is no portion where the selection line L_{PS} and the patch antenna P intersect. Therefore, according to the present comparative example, the interference between the selection line L_{PS} and the patch antenna P is reduced, as compared with the first comparative example. However, in the layout of the present comparative example, the selection line L_{PS} and the data line L_{PD} intersect with the signal line L_{S} at a plurality of locations.

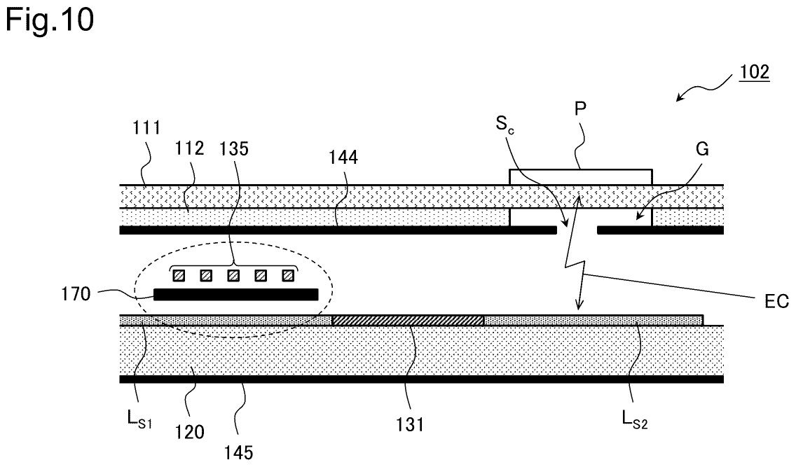

FIG. 10 is a cross-sectional view of a planar antenna of the present comparative example. The planar antenna 102 includes a patch antenna P, a first insulating layer 111, a second insulating layer 112, a phase shifter layer 130, a TFT substrate 120, TFT wiring 135, a ground layer 144, a ground layer 145, and a separation layer 170.

A plurality of patch antennas P are disposed on the upper face of the first insulating layer 111. The plurality of patch antennas P are disposed in a two-dimensional lattice pattern. The plurality of patch antennas P disposed in a two-dimensional lattice form constitutes a phased array antenna. The second insulating layer 112 is disposed on the lower face of the first insulating layer 111. The second insulating layer 112 has an opening in the lower region of the patch antenna P. The opening portion of the second insulating layer 112 forms an air gap related to the thickness of the second insulating layer 112. The ground layer 144 is disposed on the lower face of the second insulating layer 112. The ground layer 144 has a communication slot Se in a lower region of the patch antenna P.

In the layout of FIG. 10, phase shifter layer 130 is formed on the upper face of the TFT substrate 120. The signal line L_{S1} and the signal line L_{S2} are formed on the upper face of the TFT substrate 120. The phase shifter layer 130, the signal line L_{S1}, and the signal line L_{S2} are formed in the same layer. The ground layer 145 is formed on a lower face of the TFT substrate 120. The signal line L_{S2} is coupled to the patch antenna P by the electromagnetic coupling EC via the upper communication slot S_{c} and the air gap G. A signal supplied from a signal source (not illustrated) to the signal line L_{S1} is phase-shifted by a phase shifter formed in the phase shifter layer 130 and propagated to the patch antenna P through the communication slot S_{c} and the air gap G above the signal line L_{S2}.

In the layout of FIG. 10, the separation layer 170 is formed. The separation layer 170 is disposed between the ground layer 144 and the signal line L_{S}. The separation layer 170 prevents interference at an intersection between the TFT wiring 135 and the signal line L_{S}. In the case of the layout of FIG. 10, the characteristic impedance fluctuates in the vicinity of the separation layer 170.

In the present example embodiment, a ground layer is interposed between the signal line L_{S} and the TFT wiring. The ground layer is uniformly formed along an insulating layer (dielectric layer) between the signal lines (the signal line L_{S1} and the signal line L_{S2}) and the TFT wiring and a face of the TFT substrate. Therefore, according to the present example embodiment, interference can be prevented without locally providing a separation layer at the intersection of the signal lines (the signal line L_{S1} and the signal line L_{S2}) and the TFT wiring, so that the fluctuation in the characteristic impedance is reduced.

As described above, the planar antenna of the present example embodiment includes a plurality of patch antennas, a substrate, a signal line, and a ground layer. The plurality of patch antennas are disposed in a two-dimensional array. The plurality of patch antennas disposed in a two-dimensional array form an antenna array. A phase shifter layer including a phase shifter and wiring is formed on the substrate. The phase shifter is associated with each of the plurality of patch antennas. The wiring is used to control the phase shifter. The signal line is formed on the same plane as the antenna array. A communication signal propagates through the signal line. The ground layer is disposed between the phase shifter layer and the signal line. The ground layer has a slot at least between the signal line and the phase shifter.

In the planar antenna of the present example embodiment, the signal line formed on the same plane as the antenna array and the wiring of the phase shifter layer are formed in different layers. The wiring of the phase shifter layer and the signal line are separated via the ground layer. Therefore, according to the present example embodiment, the fluctuation in the characteristic impedance in the signal line, that may occur at the location where the wiring of the phase shifter layer and the signal line intersect, is suppressed.

In an aspect of the present example embodiment, the ground layer has a slot above the phase shifter. The signal line and the phase shifter are connected by electromagnetic coupling via the slot. According to the present aspect, the signal line and the phase shifter can be connected by electromagnetic coupling via the slot formed in the ground layer.

In an aspect of the present example embodiment, the signal line includes a first signal line and a second signal line. The first signal line extends from the signal source to above the first end of the phase shifter. The second signal line extends from above the second end of the phase shifter to the patch antenna. The first signal line is connected to the first end of the phase shifter by electromagnetic coupling. The second signal line is connected to the second end of the phase shifter by electromagnetic coupling. According to the present aspect, the signal propagated through the first signal line can be transmitted to the phase shifter by electromagnetic coupling, and the phase shifter can shift the signal.

In an aspect of the present example embodiment, the second signal line is formed integrally with the patch antenna. According to the present aspect, the structure and manufacturing of the second signal line and the patch antenna can be simplified.

In an aspect of the present example embodiment, the ground layer has slots below the second end of the first signal line and below the first end of the second signal line. The phase shifter is extended to the lower region of the patch antenna. According to the present aspect, by forming the slot in association with each of the first signal line and the second signal line, the interference between the upper layer and the lower layer of the ground layer is reduced. Therefore, according to the present aspect, the region of the phase shifter can be extended to below the patch antenna.

A planar antenna according to an aspect of the present example embodiment includes a first insulating layer and a second insulating layer. In the first insulating layer, the signal line and the patch antenna are disposed on the upper face, and the ground layer is disposed on the lower face. In the second insulating layer, the ground layer is disposed on the upper face, and the lower face is in contact with the upper face of the phase shifter layer. According to the present aspect, the capacitance between the signal line and the phase shifter can be set according to the dielectric constants of the first insulating layer and the second insulating layer.

In an aspect of the present example embodiment, a ground plate is disposed on the lower face of the substrate. According to the present aspect, since the ground plate is disposed on the lower face of the substrate, it is possible to prevent disturbance due to radio waves propagating from below the substrate.

The planar antenna of the present example embodiment includes a first insulating layer. A signal line and a patch antenna are disposed on the upper face of the first insulating layer. The ground layer is disposed on the upper face of the substrate with the dielectric layer interposed between the ground layer and the substrate, the dielectric layer covering the surface of the phase shifter layer. The planar antenna of the present example embodiment has a structure in which an upper layer structure and a lower layer structure are stacked. The upper layer structure includes a signal line, a patch antenna, and a first insulating layer. The lower layer structure includes a ground layer, a phase shifter layer, and a substrate. According to the present aspect, the upper layer structure and the lower layer structure can be manufactured by different manufacturing methods. For example, the upper layer structure U can be manufactured by the micro LED processing technology, and the lower layer structure L can be manufactured by the TFT processing technology.

Antenna devices compatible with electromagnetic waves in a high frequency band have been developed for mobile communication of a Beyond 5 Generation (B5G) subsequent to a 5 Generation (5G). In B5G, in order to cope with an increase in communication capacity, use of a millimeter wave or a terahertz wave is expected. Compared to radio waves used before 5G, millimeter waves and terahertz waves are easily attenuated. Therefore, the millimeter wave or the terahertz wave has a shorter communication distance than the radio wave used before 5G. When the number of elements mounted on the antenna device can be increased to a scale of 10,000, it is possible to compensate for shortening of the communication distance by improving the antenna gain. However, when the number of elements increases to a scale of 10,000,there is a possibility that a portion where a wiring line used for selection of a phase shifter or writing of data and a signal line intersect with each other and interfere with each other. When a wiring line used for selecting a phase shifter or writing data and a signal line interfere with each other, the characteristic impedance of the signal line may fluctuate.

According to the configuration of the present example embodiment, since the ground layer is disposed between the wiring and the signal line, the wiring and the signal line hardly interfere with each other. Therefore, according to the present example embodiment, the fluctuation in the characteristic impedance in the signal line, that may occur at the location where the wiring of the phase shifter layer and the signal line intersect is suppressed.

### (Second Example Embodiment)

Next, an antenna device according to a second example embodiment will be described with reference to the drawings. An antenna device of the present disclosure includes the planar antenna according to the first example embodiment. The antenna device of the present example embodiment has a configuration in which a signal source and a circuit are added to the planar antenna according to the first example embodiment. The following configuration is an example, and does not limit the configuration of the antenna device of the present disclosure.

### (Configuration)

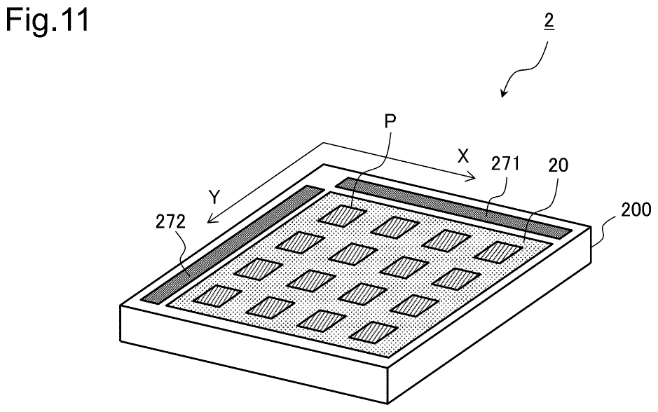

FIG. 11 is a conceptual diagram illustrating an example of a configuration of an antenna device according to the present disclosure. FIG. 11 illustrates an example of an external appearance of the antenna device. An antenna device 2 includes a planar antenna 200. The planar antenna 200 includes the planar antenna of the first example embodiment. Details of the planar antenna 200 will not be described. On the upper face of the planar antenna 200, an antenna array 20 including a plurality of patch antennas P disposed in a two-dimensional array is disposed. In the example of FIG. 11, the plurality of patch antennas P is arrayed along the X direction and the Y direction. The plurality of patch antennas P is phased arrayed.

A first drive circuit 271 and a second drive circuit 272 are mounted on antenna device 2. The first drive circuit 271 and the second drive circuit 272 are circuits used to designate the patch antennas P to be driven. By driving the first drive circuit 271 and the second drive circuit 272, the address associated with each patch antenna P can be designated. For example, the first drive circuit 271 and the second drive circuit 272 are formed on the surface of the planar antenna 200. The first drive circuit 271 and the second drive circuit 272 may be formed inside the planar antenna 200.

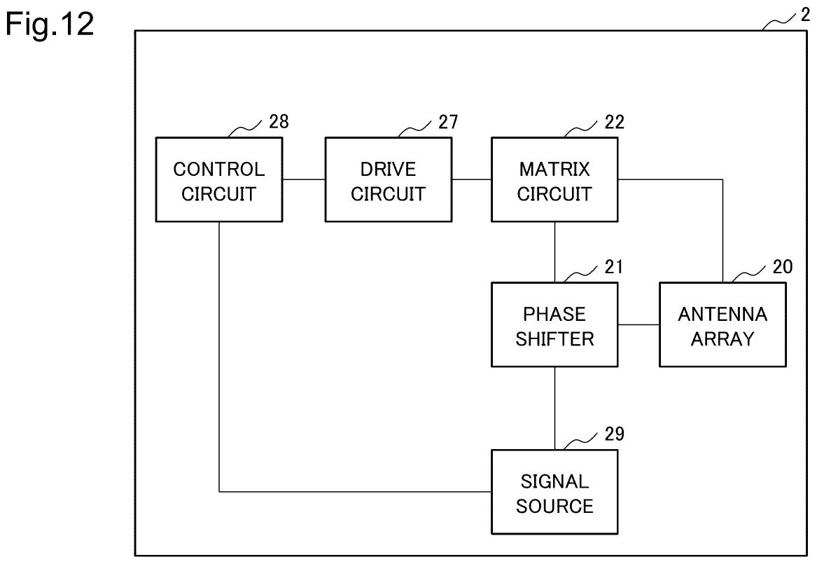

FIG. 12 is a block diagram illustrating an example of a configuration of the antenna device 2. The antenna device 2 includes an antenna array 20, a phase shifter 21, a matrix circuit 22, a drive circuit 27, a control circuit 28, and a signal source 29.

The patch antenna P is a plate-shaped radiating element. In the present example embodiment, the patch antenna P has a square shape. The shape of the patch antenna P is not limited to a square shape, and may be a circular shape or other shapes. An air gap and a slot are opened below the patch antenna P. The patch antenna P is connected to a signal line by electromagnetic coupling via an air gap and a slot formed below. The patch antenna P is an open type resonator. The patch antenna P resonates at a frequency that matches an integral multiple of ½ wavelength of the length of the patch antenna P. The size of the patch antenna P is set in accordance with the wavelength of the radio wave used for communication.

The matrix circuit 22 has a configuration in which a plurality of thin film transistors (TFT) is disposed in a two-dimensional array. The matrix circuit 22 is formed using a TFT processing technology. For example, a ground layer is formed above the matrix circuit 22. The ground layer is formed to prevent electromagnetic coupling above and below the ground layer. For example, the ground layer includes an electric conductor. The potential of the ground layer is basically a ground potential. Therefore, a capacitance related to the dielectric constant of the dielectric layer such as the insulating layer or the TFT substrate is formed between the signal line included in the phase shifter 21 and the ground layer. Each of the plurality of TFTs included in the matrix circuit 22 is associated with one of the plurality of patch antennas P included in the antenna array 20. For example, the TFT includes a semiconductor layer such as amorphous silicon, polysilicon, or an oxide semiconductor.

The phase shifter 21 is disposed for each antenna unit. The phase shifter 21 is any of the phase shifters included in the planar antenna of the first example embodiment.

The drive circuit 27 includes the first drive circuit 271 and the second drive circuit 272. The first drive circuit 271 is a circuit for performing addressing in the X direction. The second drive circuit 272 is a circuit for performing addressing in the Y direction. The drive circuit 27 drives the first drive circuit 271 and the second drive circuit 272 to designate an address associated with each patch antenna P. The drive circuit 27 drives the plurality of TFTs included in the matrix circuit 22 under the control of the control circuit 28. The drive circuit 27 individually drives the plurality of TFTs disposed in a two-dimensional array.

The control circuit 28 drives the drive circuit 27 in accordance with a control signal from the outside. The control circuit 28 drives the drive circuit 27 by an active matrix drive system. The control circuit 28 outputs a control signal from the outside to the signal source 29. For example, the control circuit 28 is achieved by a microcomputer or a microcontroller. For example, the control circuit 28 includes a central processing unit (CPU), a random access memory (RAM), a read only memory (ROM), a flash memory, and the like. The control circuit 28 executes control and processing according to a program stored in advance. The control circuit 28 executes control and processing according to a program according to a preset schedule and timing, an external control instruction, and the like. For example, the control circuit 28 controls the antenna array 20 including the plurality of patch antennas P included in the planar antenna 200 to transmit a radio wave having directivity from the antenna array 20. As described above, the antenna array 20 is used as a phased array antenna.

The signal source 29 is connected to a plurality of switch groups SW included in the phase shifter 21. The signal source 29 is connected to the control circuit 28. The signal source 29 acquires a control signal from the control circuit 28. The signal source 29 controls ON/OFF of the plurality of switch groups SW constituting the switch group according to the control signal. The signal source 29 may be configured to directly receive a control signal from the outside without going through the control circuit 28.

The signal reaching the signal input unit of the phase shifter 21 through a signal line (not illustrated) connected to the TFT in the ON state is phase-shifted by the line length set in the phase shifter 21 and the phase shift amount according to the dielectric constant of the dielectric such as the insulating layer or the TFT substrate. The phase-shifted signal propagates from the signal line to the patch antenna P by electromagnetic coupling. The signal propagated to the patch antenna P is transmitted from the patch antenna P as a radio wave to be transmitted. The radio wave transmitted from the patch antenna P is based on a signal output from a transmission circuit (not illustrated). The information included in the signal is not particularly limited.

The radio wave received by the patch antenna P is received according to the capacitance based on the dielectric constant of the dielectric such as the insulating layer or the TFT substrate interposed between the patch antenna P and the signal line. The phase of the received radio wave is shifted by the line length set in the phase shifter 21 and the phase shift amount according to the dielectric constant of the dielectric such as the insulating layer and the TFT substrate. The phase-shifted signal is received by a reception circuit (not illustrated) through a signal line. Information included in the signal received by the reception circuit is decoded by a decoder (not illustrated).

As described above, the antenna device of the present example embodiment includes the planar antenna, the signal source, the matrix circuit, the drive circuit, and the control circuit according to the first example embodiment. The signal source is connected to a signal line included in the planar antenna. The matrix circuit has a structure in which a plurality of thin film transistors connected to wiring included in a planar antenna is disposed in a two-dimensional array. The drive circuit drives a thin film transistor included in the matrix circuit. The control circuit drives the drive circuit according to the control signal. The antenna device of the present aspect includes the planar antenna according to the first example embodiment. Therefore, according to the present aspect, it is possible to provide the antenna device in which the fluctuation in the characteristic impedance in the signal line included in the planar antenna is suppressed.

In an aspect of the present example embodiment, the control circuit controls the plurality of patch antennas included in the planar antenna to transmit a radio wave having directivity from the antenna array including the plurality of patch antennas. According to the present aspect, an antenna array including a plurality of patch antennas can be used as a phased array antenna.

### (Third Example Embodiment)

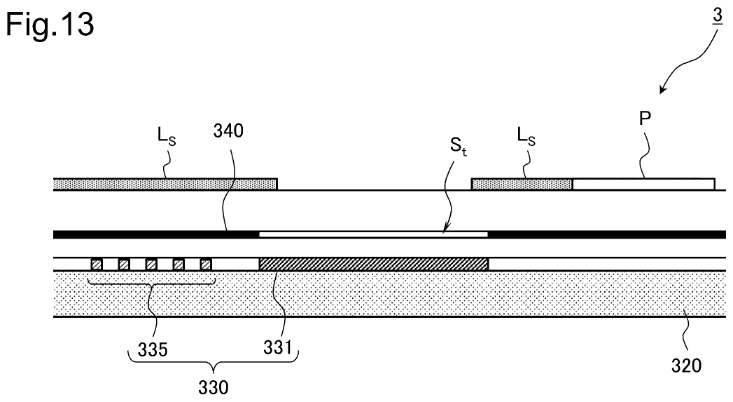

Next, a planar antenna according to a third example embodiment will be described with reference to the drawings. The planar antenna of the present example embodiment has a configuration in which the planar antenna of the first example embodiment is simplified. FIG. 13 is a conceptual diagram illustrating an example of a configuration of a planar antenna according to the present disclosure; and A planar antenna 3 includes a plurality of patch antennas P, a substrate 320, a signal line Ls, and a ground layer 340.

The plurality of patch antennas P are disposed in a two-dimensional array. The plurality of patch antennas P disposed in a two-dimensional array form an antenna array. The phase shifter layer 330 including a phase shifter 331 and wiring 335 is formed on substrate 320. The phase shifter 331 is associated with each of the plurality of patch antennas P. The wiring 335 is used to control the phase shifter 331. The signal line L_{S} is formed on the same plane as the antenna array. A communication signal propagates through the signal line L_{S}. The ground layer 340 is disposed between the phase shifter layer 330 and the signal line L_{S}. The ground layer 340 has a slot at least between the signal line Ls and the phase shifter 331.

In the planar antenna of the present example embodiment, the signal line formed on the same plane as the antenna array and the wiring of the phase shifter layer are formed in different layers. The wiring of the phase shifter layer and the signal line are separated via the ground layer. Therefore, according to the present example embodiment, the fluctuation in the characteristic impedance in the signal line, that may occur at the location where the wiring of the phase shifter layer and the signal line intersect, is suppressed.

### (Hardware)

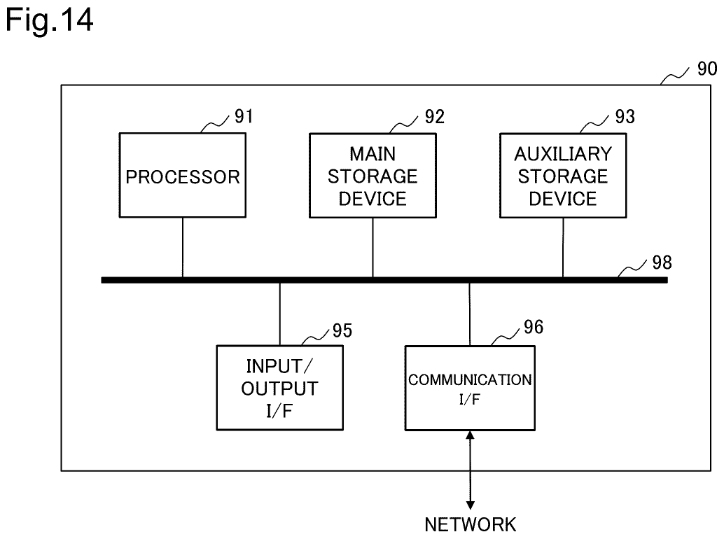

Next, a hardware configuration for executing control and processing in the present disclosure will be described with reference to the drawings. An example of such a hardware configuration is an information processing device 90 (computer) in FIG. 14.

The information processing device 90 in FIG. 14 is a configuration example for executing control and processing in the present disclosure, and does not limit the scope of the present disclosure.

As illustrated in FIG. 14, the information processing device 90 includes a processor 91, a memory 92, an auxiliary storage device 93, an input/output interface 95, and a communication interface 96. In FIG. 14, the interface is abbreviated as an interface (I/F). The processor 91, the memory 92, the auxiliary storage device 93, the input/output interface 95, and the communication interface 96 are data-communicably connected to each other via a bus 98. The processor 91, the memory 92, the auxiliary storage device 93, and the input/output interface 95 are connected to a network such as the Internet or an intranet via the communication interface 96.

The processor 91 develops a program (instruction) stored in the auxiliary storage device 93 or the like in the memory 92. For example, the program is a software program for executing control and processing in the present disclosure. The processor 91 executes the program developed in the memory 92. The processor 91 executes control and processing in the present disclosure by executing a program.

The memory 92 is a memory having an area in which a program is developed. A program stored in the auxiliary storage device 93 or the like is developed in the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92.

The auxiliary storage device 93 stores various pieces of data such as programs. For example, the auxiliary storage device 93 is achieved by a local disk such as a hard disk or a flash memory. Various pieces of data may be stored in the memory 92, and the auxiliary storage device 93 may be omitted.

The input/output interface 95 is an interface that connects the information processing device 90 with a peripheral device based on a standard or a specification. The communication interface 96 is an interface that connects to an external system or a device through a network such as the Internet or an intranet in accordance with a standard or a specification. As an interface connected to an external device, the input/output interface 95 and the communication interface 96 may be shared.

An input device such as a keyboard, a mouse, or a touch panel may be connected to the information processing device 90 as necessary. These input devices are used to input of information and settings. In a case where a touch panel is used as the input device, a screen having a touch panel function serves as an interface. The processor 91 and the input device are connected via the input/output interface 95.

The information processing device 90 may be provided with a display device that displays information. In a case where a display device is provided, the information processing device 90 includes a display control device (not illustrated) that controls display of the display device. The information processing device 90 and the display device are connected via the input/output interface 95.

The information processing device 90 may be provided with a drive device.

The drive device mediates reading of data and a program stored in a recording medium and writing of a processing result of the information processing device 90 to the recording medium between the processor 91 and the recording medium (program recording medium). The information processing device 90 and the drive device are connected via an input/output interface 95.

The above is an example of a hardware configuration for enabling control and processing in the present disclosure. The hardware configuration of FIG. 14 is an example of a hardware configuration for executing control and processing in the present disclosure, and does not limit the scope of the present disclosure. A program for causing a computer to execute control and processing in the present disclosure is also included in the scope of the present disclosure.

A program recording medium in which a program for executing processing in the present example embodiment is recorded is also included in the scope of the present disclosure. For example, the program recording medium is a computer-readable non-transitory recording medium. The recording medium can be achieved by, for example, an optical recording medium such as a compact disc (CD) or a digital versatile disc (DVD). The recording medium may be achieved by a semiconductor recording medium such as a Universal Serial Bus (USB) memory or a secure digital (SD) card. The recording medium may be achieved by a magnetic recording medium such as a flexible disk, or another recording medium.

The components in the present disclosure may be combined in any manner. The components in the present disclosure may be implemented by software. The components in the present disclosure may be implemented by a circuit.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

Some or all of the above example embodiments may be described as the following Supplementary notes, but are not limited to the following. In the following

Supplementary notes, each category's dependent term may also be dependent on other categories. The description included in the following Supplementary notes has significance as a basis for amendment.

### (Supplementary Note 1)

A planar antenna including
an antenna array in which a plurality of patch antennas are disposed in a two-dimensional array;
a substrate on which a phase shifter layer including a phase shifter associated with each of the plurality of patch antennas and wiring used for controlling the phase shifter is formed;
a signal line that is disposed on the same plane as the antenna array and through which a communication signal propagates; and
a ground layer disposed between the phase shifter layer and the signal line, and having a slot formed at least between the signal line and the phase shifter.

### (Supplementary Note 2)

The planar antenna according to Supplementary Note 1, wherein
the ground layer has the slot above the phase shifter, and
the signal line and the phase shifter are connected by electromagnetic coupling via the slot.

### (Supplementary Note 3)

The planar antenna according to Supplementary Note 2, wherein
the signal line includes
a first signal line extending from a signal source to above a first end of the phase shifter and
a second signal line extending from above a second end of the phase shifter to the patch antenna, and wherein
the first signal line is connected to the first end of the phase shifter by electromagnetic coupling, and
the second signal line is connected to the second end of the phase shifter by electromagnetic coupling.

### (Supplementary Note 4)

The planar antenna according to Supplementary Note 3, wherein
the second signal line is formed integrally with the patch antenna.

(Supplementary Note 5)

The planar antenna according to Supplementary Note 3, wherein
the ground layer has the slot below a second end of the first signal line and below a first end of the second signal line, and
the phase shifter
extends to a lower region of the patch antenna.

### (Supplementary Note 6)

The planar antenna according to Supplementary Note 1, further including
a first insulating layer having an upper face on which the signal line and the patch antenna are disposed and a lower face on which the ground layer is disposed, and
a second insulating layer having an upper face on which the ground layer is disposed and a lower face with which an upper face of the phase shifter layer is in contact.

### (Supplementary Note 7)

The planar antenna according to Supplementary Note 6, wherein
a ground plate is disposed on a lower face of the substrate.

(Supplementary Note 8)

The planar antenna according to Supplementary Note 5, further including
a first insulating layer having an upper face on which the signal line and the patch antenna are disposed, wherein
the ground layer is disposed on an upper face of the substrate with a dielectric layer interposed between the ground layer and the substrate, the dielectric layer covering a surface of the phase shifter layer, and
an upper layer structure including the signal line, the patch antenna, and the first insulating layer and a lower layer structure including the ground layer, the phase shifter layer, and the substrate are stacked.

### (Supplementary Note 9)

An antenna device including
the planar antenna according to any one of Supplementary Notes 1 to 8,
a signal source connected to the signal line included in the planar antenna,
a matrix circuit in which a plurality of thin film transistors connected to wiring included in the planar antenna is disposed in a two-dimensional array,
a drive circuit that drives the thin film transistor included in the matrix circuit, and
a control circuit that drives the drive circuit in accordance with a control signal.

### (Supplementary Note 10)

The antenna device according to Supplementary Note 9, wherein
the control circuit causes the plurality of patch antennas included in the planar antenna to transmit a radio wave having directivity from the antenna array configured by the plurality of patch antennas.

1. A planar antenna comprising:
an antenna array in which a plurality of patch antennas are disposed in a two-dimensional array;
a substrate on which a phase shifter layer including a phase shifter associated with each of the plurality of patch antennas and wiring used for controlling the phase shifter is formed;
a signal line that is disposed on the same plane as the antenna array and through which a communication signal propagates; and
a ground layer disposed between the phase shifter layer and the signal line, and having a slot formed at least between the signal line and the phase shifter.

2. The planar antenna according to claim 1, wherein
the ground layer has the slot above the phase shifter, and
the signal line and the phase shifter are connected by electromagnetic coupling via the slot.

3. The planar antenna according to claim 2, wherein
the signal line includes
a first signal line extending from a signal source to above a first end of the phase shifter and
a second signal line extending from above a second end of the phase shifter to the patch antenna, and wherein
the first signal line is connected to the first end of the phase shifter by electromagnetic coupling, and
the second signal line is connected to the second end of the phase shifter by electromagnetic coupling.

4. The planar antenna according to claim 3, wherein
the second signal line is formed integrally with the patch antenna.

5. The planar antenna according to claim 3, wherein
the ground layer has the slot below a second end of the first signal line and below a first end of the second signal line, and
the phase shifter extends to a lower region of the patch antenna.

6. The planar antenna according to claim 1, further comprising:
a first insulating layer having an upper face on which the signal line and the patch antenna are disposed, and a lower face on which the ground layer is disposed; and
a second insulating layer having an upper face on which the ground layer is disposed and a lower face with which an upper face of the phase shifter layer is in contact.

7. The planar antenna according to claim 6, wherein
a ground plate is disposed on a lower face of the substrate.

8. The planar antenna according to claim 5, further comprising:
a first insulating layer having an upper face on which the signal line and the patch antenna are disposed, wherein
the ground layer is disposed on an upper face of the substrate with a dielectric layer interposed between the ground layer and the substrate, the dielectric layer covering a face of the phase shifter layer, and
an upper layer structure including the signal line, the patch antenna, and the first insulating layer and a lower layer structure including the ground layer, the phase shifter layer, and the substrate are stacked.

9. An antenna device comprising:
the planar antenna according to claim 1;
a signal source connected to the signal line included in the planar antenna;
a matrix circuit in which a plurality of thin film transistors connected to wiring included in the planar antenna is disposed in a two-dimensional array;
a drive circuit that drives the thin film transistor included in the matrix circuit; and
a control circuit that drives the drive circuit in accordance with a control signal.

10. The antenna device according to claim 9, wherein
the control circuit causes the plurality of patch antennas included in the planar antenna to transmit a radio wave having directivity from the antenna array configured by the plurality of patch antennas.
